(19) United States
(12) Patent Application Publication
(10) Pub. No.: US 2011/0264396 A1
(43) Pub. Date: Oct. 27, 2011

(54) ELECTRICAL CIRCUIT WITH PHYSICAL LAYER DIAGNOSTICS SYSTEM

(75) Inventors: Renato Kitchener, West Sussex (GB); Gunther Rogoll, Mannheim (DE); Steffen Graber, Mannheim (DE)

(73) Assignee: PEPPERL + FUCHS GMBH, Mannheim (DE)

(21) Appl. No.: 12/745,044

(22) PCT Filed: Nov. 28, 2008
(86) PCT No.: PCT/GB08/03960

§ 371 Date: Dec. 20, 2010

(30) Foreign Application Priority Data
Nov. 30, 2007 (GB) 0723481.8

(51) Int. Cl. G06F 19/00

(52) U.S. Cl. 702/117

(57) ABSTRACT

An electrical circuit has a power supply, one or more devices and a diagnostics system. The diagnostics system includes a monitoring means adapted to monitor physical layer characteristics of the electrical circuit, a database containing circuit design data for the electrical circuit, and comparator means adapted to diagnose the status of the monitored physical layer characteristics of the electrical circuit by comparing them with the circuit design data.

### CROSS-REFERENCE TO RELATED APPLICATIONS

The present application is a national phase entry under 35 U.S.C. §371 of International Application No. PCT/GB2008/003960 filed Nov. 28, 2008, published in English, which claims priority from GB0723481.8 filed Nov. 30, 2007, all of which are incorporated herein by reference.

### BACKGROUND OF THE INVENTION

This invention relates to an electrical circuit with a physical layer diagnostics system, for use particularly, but not exclusively, as an improved Fieldbus physical layer diagnostics system.

Fieldbus (or field bus) is the name of a family of industrial computer network protocols used for real-time distributed control, now standardized as IEC 61158. A complex automated industrial system, for example a fuel refinery, usually needs an organized hierarchy of controller systems to function. In this hierarchy there is a Human Machine Interface (HMI) at the top, where an operator can monitor or operate the system. This is typically linked to a middle layer of programmable logic controllers (PLC) via a non time critical communications system (e.g. Ethernet). At the bottom of the control chain is the fieldbus which links the PLCs to the components which actually do the work such as sensors, actuators, electric motors, console lights, switches, valves and contactors.

Fieldbus is often used in Intrinsically Safe environments, for example combustible atmospheres, and in particular gas group classification UC, Hydrogen and Acetylene, and below, for example gas group HB and HA, for gas and/or dust. Using the Fieldbus protocol, field instruments and equipment in such an environment are powered by an Intrinsically Safe electrical circuit which is also used to control and monitor the field instruments remotely.

Fieldbus physical layer diagnostics for IEC 61158 type networks has been introduced successfully to the mainstream processing industry in the last few years. For example, FIG. 1 shows a typical electrical power and communications circuit comprising a power supply 1, a trunk section 2, a device coupler 3 and spur sections 4 connected thereto. Devices 5 are mounted on the spur sections 4, and in use they send data signals to a control system 6 mounted some distance away on the trunk section 2. A diagnostic module 7 is also mounted to the trunk section 2, usually at the same location as the control system 6, and it works by measuring physical layer variables associated with the network hardware, and in part, the physical software or protocol being used for communications.

However, known diagnostics modules like module 3 simply measure physical layer variables and either send this information to the control system 6 for further diagnostics, or generate simple alarms if the monitored variables breach one or more pre-determined thresholds. To create such functionality these threshold must be programmed into the diagnostics module 3, which is time consuming. Human errors can also be made.

When fieldbus circuits like that shown in FIG. 1 are designed prior to implementation, the designers use software tools to create a simulation of the circuit, which can be tested. Such a software tool is the Segment Checker open software tool. Segment Checker supports central and distributed Fieldbus architectures for Foundation Fieldbus Hl and Profibus PA, and it facilitates the designing and simulated testing of possible Fieldbus segments to check their plausibility. The simulated circuit designs created on Segment Checker, or other similar programs, include the physical layer attributes of the designed circuit, for example the total segment current, device tags, cable lengths, cable type and so on.

However, created circuit designs like those described above are not incorporated into the operational functioning of actual electrical circuits. Often the circuit design is electronically stored in a control system for the actual circuit, but only for future manual reference and for maintenance records.

Therefore, to date IEC61158 physical layer design software and actual monitored physical layer data have never been correlated in an automated way, and no diagnostics system has been provided with the infrastructure to perform such correlation. The only way to validate monitored physical layer data against the circuit design would be to do so manually some time after the monitoring has taken place, which does not allow for instantaneous fault detection and correction. In addition, errors can occur when comparing data manually.

### SUMMARY OF THE INVENTION

The present invention is intended to overcome some of the above problems.

Therefore, according to the present invention an electrical circuit comprises a power supply, one or more devices and a diagnostics system, in which the diagnostics system comprises monitoring means adapted to monitor physical layer characteristics of the electrical circuit, a database containing circuit design data for the electrical circuit, and comparator means adapted to diagnose the status of the monitored physical layer characteristics of the electrical circuit by comparing them with the circuit design data.

With this arrangement a diagnostics module can compare monitored physical layer characteristics of the electrical circuit directly with the original design for that circuit. As such the diagnostics module has a significant database of information against which to compare the real-time incoming data, and to diagnose many more types of faults than were previously possible. For example, a circuit design may comprise three field devices, each of which draws a different current. If the monitored current in the circuit drops by an amount substantially the same as one of those devices, then the diagnostics module can diagnose a fault with that particular device, by referring to the circuit design data.

The circuit design data can comprise a circuit design generated by a circuit design tool, and can comprise a plurality of normal operating references. These references can be one or more of: the voltage and/or current level of the circuit design; the length and/or type and/or resistance and/or identity of cables of the circuit design; the signal amplitude and/or identity of devices incorporated into the circuit design; operating parameters of device couplers incorporated into the circuit design.

In an enhanced version of the invention the monitoring means can be adapted to monitor external influences which might have an effect on the operation of the electrical circuit, for example atmospheric conditions like the air temperature, pressure and humidity around the circuit, as well factors like the time of day or year. Sensors and clocks which provide such information are known. In line with this, the normal operating references can alter according to changes in these external influences. For example according to the design the normal current at 80 degrees Fahrenheit might be different to the normal current at 20 degrees Fahrenheit. The comparator means can then be

adapted to diagnose the status of the monitored physical layer characteristics of the electrical circuit by comparing them with the normal operating references according to the prevailing monitored external influences. This arrangement provides adaptable realtime real-condition diagnostics.

The circuit design of the invention can be generated using any known software program, however in a preferred construction the circuit design can comprise a Segment Checker circuit design generated by the Segment Checker open software program. This program is used by the applicant and its rivals to design and test Fieldbus circuits for their customers, and as such circuit designs always already exist for any electrical circuit which is put into effect. Therefore, the normal operating references used by the diagnostics system do not need to be created and entered as a separate process. This helps to avoid programming errors, and reduces the time and cost of implementing an effective diagnostics system.

Preferably the diagnostics system comprises a diagnostics module comprising an operating system with a controlling program loaded onto the operating system. The database can also be loaded onto the operating system. The controlling program can comprise a monitoring sub-program adapted to receive physical layer data from the electrical circuit, a comparison sub-program adapted to compare said physical layer data with normal operating references stored in the database, and a fault warning subprogram adapted to generate fault signals when said physical layer data deviates from the normal operating references by pre-determined margins. The manner in which such software can be created is well known, and a suitably skilled person would be able to put these functions into effect without recourse to inventive skill.

The monitoring sub-program can also be adapted to receive external influence data from external sensors with which the electrical circuit is used. The fault warning sub-program can therefore be adapted to generate fault signals when said physical layer data deviates by pre-determined margins from the normal operating references according to the prevailing monitored external influences. Again, a suitably skilled person would be able to put these functions into effect.

In one version of the invention the comparison sub-program can be adapted to make inference calculations about one or more unknown characteristics of the electrical circuit by working the physical layer data received by the monitoring subprogram and/or the normal operating references. For example, the comparison subprogram could calculate an actual cable length by calculating the attenuation of a monitored device signal level, then comparing that with known cable and device characteristics forming a part of the circuit design.

The diagnostics module can further comprise a screen, and the controlling program can comprise a graphical interface sub-program adapted to generate graphics on the screen relating to physical layer data and external influence data received by the monitoring sub-program, and/or the normal operating references of the circuit design stored in the database, and/or fault warnings generated by the fault warning subprogram. This allows operators to access the diagnostics module directly.

Alternatively, or in addition to the above, the electrical circuit can comprise a control system adapted to send and receive data signals to and from the one or more devices, and the diagnostics module can comprise an input/output connected to the control system. The diagnostics module can be adapted to send to the control system physical layer data and external influence data received by the monitoring sub-program, and/or the normal operating references of the circuit design stored in the database, and/or fault warnings generated by the fault warning sub-program.

It will be appreciated that in practice there are various ways that diagnostics can be applied to an electrical circuit, part of which passes through a control room, and part of which extends into an intrinsically safe field. The diagnostics module can be disposed in the control room itself, in which case a screen may not be necessary, or it can be positioned out in the field, in which case a screen or other interface would be necessary. In addition, the diagnostics module can comprise all the functions of the invention described above in a single unit, either in the control room or outside of it, or the diagnostics system can be incorporated into the control system, in which case the functions of the invention described above may be dispersed within a greater control and monitoring system.

As referred to above the invention is preferably used as an intrinsically safe power and communications Fieldbus circuit, which conforms to the IEC 61158 protocol, although it will be appreciated that this is not essential.

It will also be appreciated that the an electrical circuit according to the invention can be created by retro-fitting a diagnostics module to an existing electrical circuit. Therefore, according to a second aspect of the present invention, a diagnostics system is provided, for use with an electrical circuit as in any of claims 1 to 12 below.

### BRIEF DESCRIPTION OF THE DRAWINGS

The invention can be performed in various ways, but one embodiment will now be described by way of example and with reference to the accompanying drawings, in which:

FIG. 1 is a diagrammatic view of a prior art electrical circuit comprising a diagnostics system;

FIG. 2 is a diagrammatic view of an electrical circuit according to the present invention;

FIG. 3 is a block diagram of the diagnostics module shown in FIG. 2;

FIGS. 4 and 5 are screen-shots of the Segment Checker software program, used to create the circuit design shown in FIG. 3.

### DETAILED DESCRIPTION

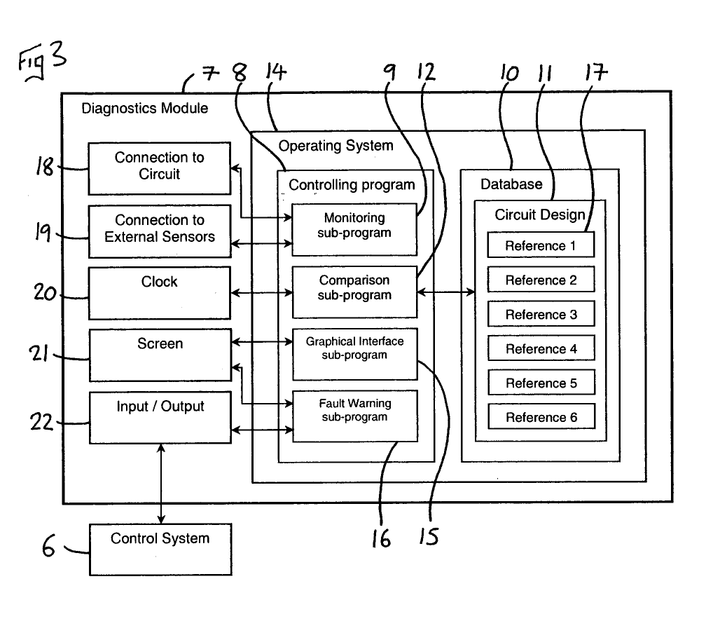

As shown in FIG. 2 an electrical circuit comprises a power supply 1, one or more devices, in the form of field devices 5, and a diagnostics system, in the form of diagnostics module 7, which includes controlling program 8, described further below. The diagnostics system 7 comprises monitoring means adapted to monitor physical layer characteristics of the electrical circuit, in the form of monitoring sub-program 9, shown in FIG. 3, and a database 10 containing circuit design data 11 for the electrical circuit. The diagnostics system 7 also comprises comparator means, in the form of comparison sub-program 12, adapted to diagnose the status of the monitored physical layer characteristics of the electrical circuit by comparing them with the circuit design data 11.

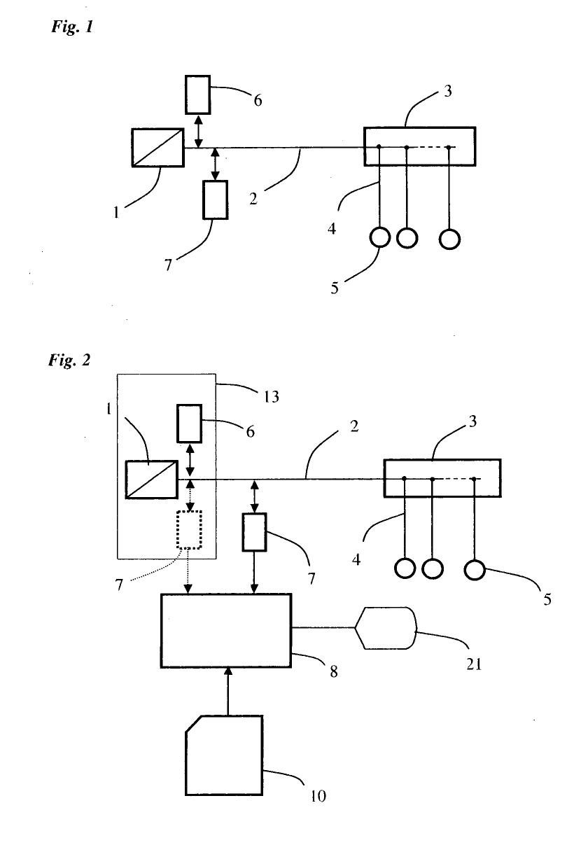

The electrical circuit is a Fieldbus circuit constructed like that shown in FIG. 1, and where component parts are the same like reference numbers have been used. In particular, the electrical circuit comprises a trunk section 2, a device coupler 3, and spur sections 4 connected thereto. Field devices 5 are mounted on the spur sections 4, and in use they send data signals to a control system 6. The trunk section 2 is non- intrinsically safe, while the spur sections 4 are rendered intrinsically safe by systems incorporated into the device coupler 3. Any of the known methods can be employed to render the spurs 4 intrinsically safe. The power supply 1 and the control system 6 are located in a control room 13, and the rest of the circuit is located in the field. The diagnostics module 7 is shown as being mounted to the trunk section 2 outside of the control room 13, but it is also possible to locate the diagnostics module 7 inside the control room if desired, and this alternative is shown in hashed lines as a possibility in FIG. 2.

In terms of its monitoring functionality the diagnostics module 7 works in the same way as known systems, and measures the physical layer variables associated with the network hardware, and in part, the physical software or protocol being used for communications between the field devices 5 and the control system 6. However, as illustrated in FIG. 2 the diagnostics module 7 is provided with a controlling program 8 and the database 10 to enhance its functionality.

Referring now to FIG. 3, the diagnostics module 7 comprises an operating system 14, which has the controlling program 8 and the database 10 loaded onto it. The controlling program 8 comprises the monitoring sub-program 9, the comparison sub-program 12, a graphical interface sub-program 15 and a fault warning sub-program 16. The database 10 has the circuit design loaded onto it, which comprises a plurality of normal operating references 17. For ease of explanation six references are shown in FIG. 3, but it will be appreciated that in practice this number would be far greater. The references 17 comprise figures for one or more of the voltage and/or current level of the circuit design; the length and/or type and/or resistance and/or identity of cables of the circuit design; the signal amplitude and/or identity of devices incorporated into the circuit design; operating parameters of device couplers incorporated into the circuit design, and any number of other such factors.

When a particular reference 17 relates to a physical layer variable, for example the voltage level, then the reference is a figure for the intended voltage level of the electrical circuit. When a particular reference 17 relates to a static characteristic or identifier, for example a cable length or a field device tag, then the reference can be that figure or textual identifier.

When a particular reference 17 can be affected by one or more external influences, for example the air temperature, then that reference 17 comprises a range of figures which change according to the level of that external influence. When a reference 17 can be altered by a plurality of external influences then that reference 17 can comprise an algorithm which produces a given result according to two or more variable factors.

The diagnostics module 7 also comprises a connection to the electrical circuit 18, by which it monitors the various physical layer characteristics. It also comprises a connection to external sensors 19, by which it monitors a number of external influences, for example the air temperature, pressure and humidity around the circuit. These sensors are not shown in the Figures, but it will be appreciated that such sensors are well known and can easily be connected to the diagnostics module 7. Incoming data from the external sensors is fed to the monitoring sub-program 9, and the comparison sub-program 12 refers to this data when it is a factor which affects one or more of the references 17, as described above.

In addition, the diagnostics module 7 comprises an internal clock 20, by which the comparison sub-program 12 can refer to the time of day or time of year, which can also be external influences factored into one or more of the references 17.

The fault warning sub-program 16 is adapted to generate fault warnings when incoming data from the circuit and/or the external sensors deviates by a pre-determined margin from the references 17, as determined by the comparisons carried out by the comparison sub-program 12.

The diagnostics module 7 further comprises a screen 21, and the graphical interface sub-program 15 is adapted to generate graphics on the screen 21 relating to

physical layer data and external influence data received by the monitoring sub-program 9 in use. It also generates graphics on the screen 21 relating to fault warnings generated by the fault warning sub-program 16 in use, as described above. The screen can also display the references 17 stored in the database. The diagnostics module 7 comprises interface keys (not shown) adapted to allow these various different types of data to be accessed by the operator. Such systems are known.

In addition to this, the diagnostics module 7 comprises an input/output 22, by which it is connected to the control system 6. The controlling program 8 sends data to the control system 6 relating to the physical layer data and external influence data received by the monitoring sub-program 9 in use, as well as any fault warnings generated by the fault warning sub-program 16 in use. The protocols which dictate how and when this data is sent to the control system can be established by those who implement the system, and it will be appreciated that any suitable arrangement can be put in place.

The control system 6 can also send command data to the diagnostics module 7 to either change its operating procedures or the references 17. Again, the manner in which this is achieved, and the levels of functionality are not essential to the invention, and can be implemented in any suitable way according to the particular on-site requirements.

(The controlling program 8 performs the general processing actions performed by the diagnostics module 7 herein described, however it will be appreciated that in practice programs interact with other programs on a computerised operating system in a complex way in order to perform their functions. FIG. 3 is a very simple diagram intended to show the basic operating features of the diagnostics module 7, and for ease of explanation these functions are divided between a small number of illustrated subprograms. However, it will be appreciated that in practice such clearly defined boundaries may not be appropriate, and there will be any number of other standard programs and sub-programs which are not shown but which are required for the controlling program 8 to operate. FIG. 3 is not intended to be understood as anything other than a diagrammatic view of the various features of the invention, and how they interact with one another.)

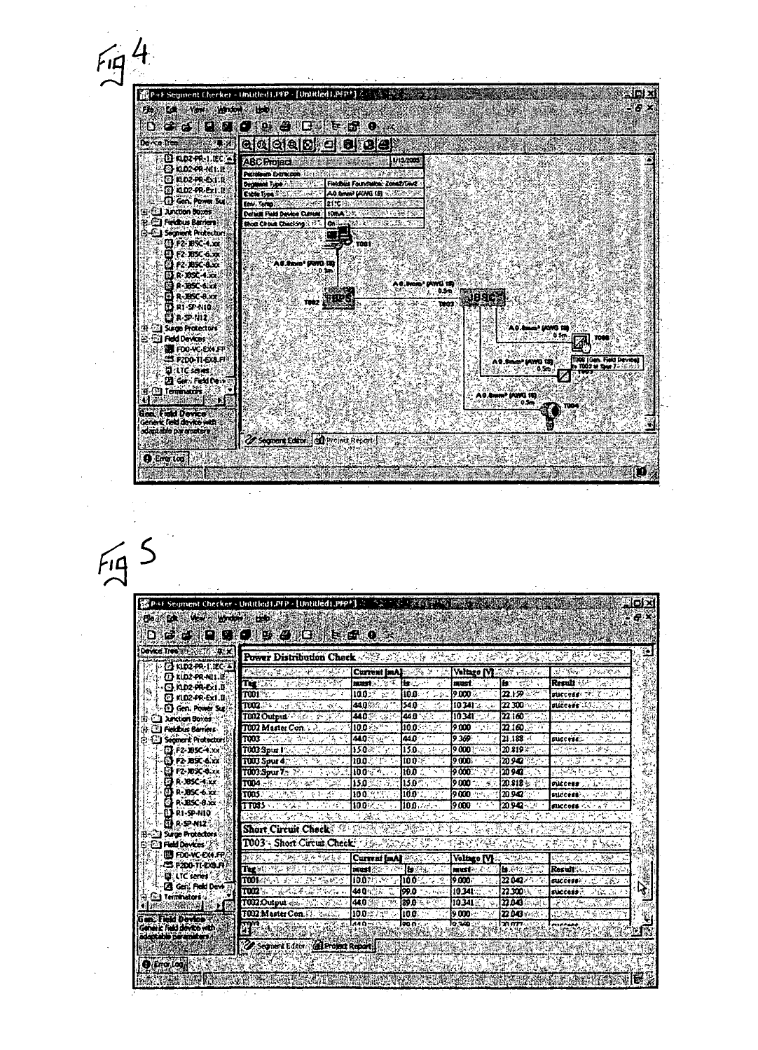

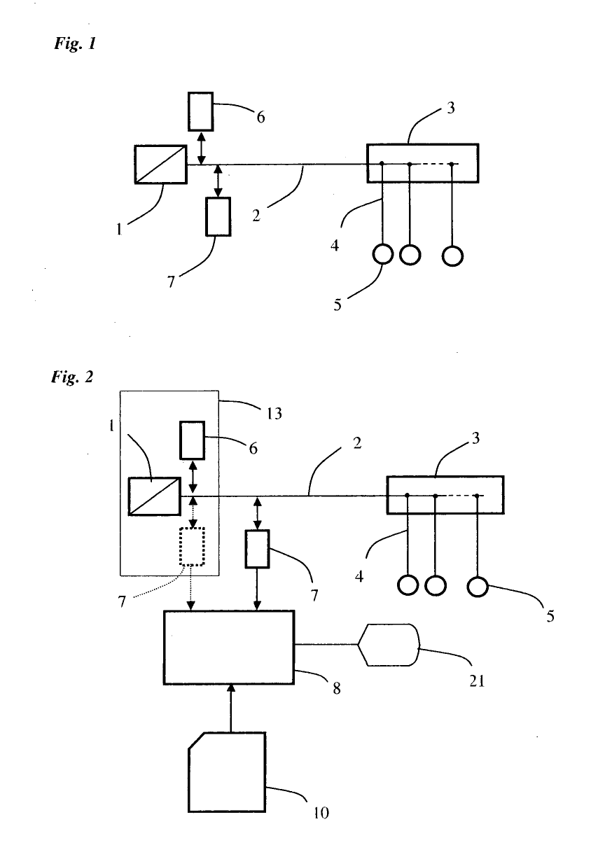

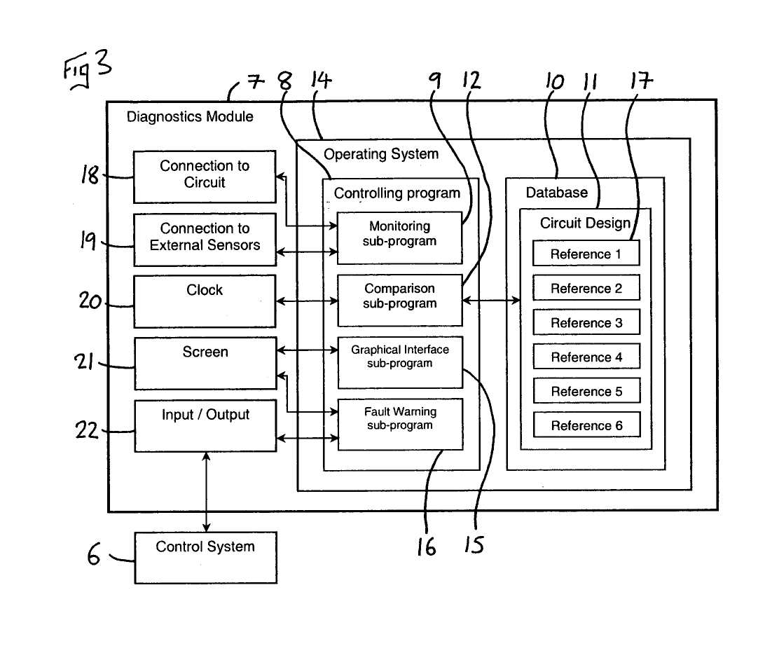

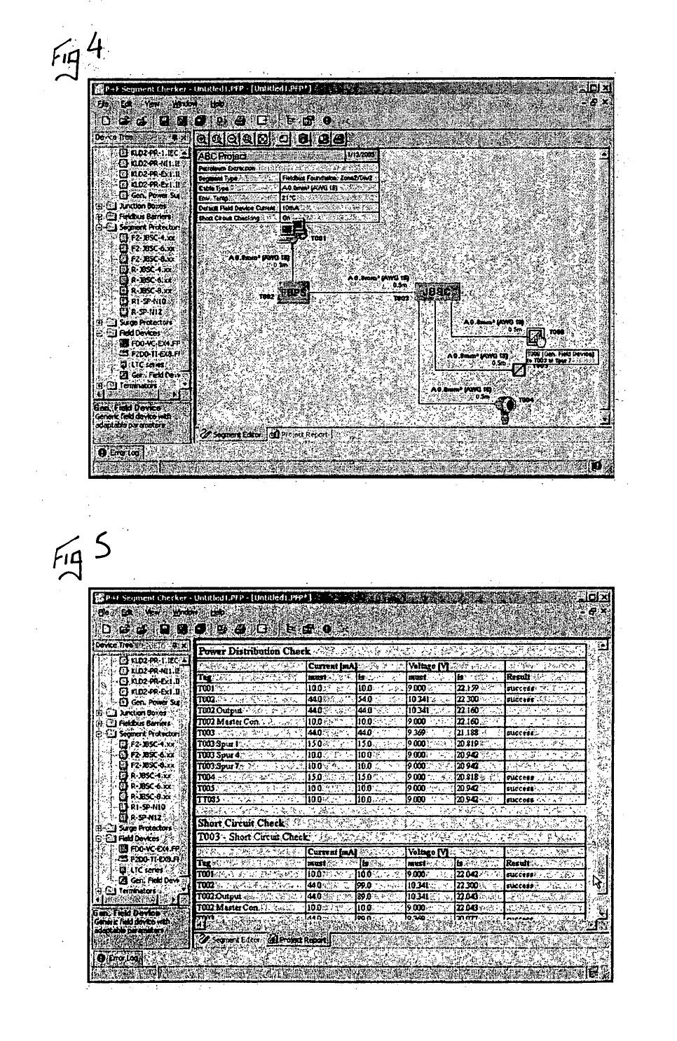

The circuit design 11 is generated using the Segment Checker open software program. FIGS. 4 and 5 show screen shots of the Segment Checker program, and illustrate some of its functionality. For example, FIG. 4 shows a graphical interface part of the program where a circuit design can be created with various components connected to one another in a particular configuration. FIG. 5 shows a physical layer characteristic checking part of the program where current and voltage at various parts of the circuit design are tested.

A circuit design can be saved in Segment Checker, and that saved file contains all the data relating to a circuit design which is generated during the normal usage of the software. The circuit design 11 stored in the database is such a file, and the controlling program 8 is constructed to be able to interface with that saved file and access the relevant data. It will be appreciated that a skilled software engineer will be able to create software which can achieve this result without recourse to inventive input.

Therefore, in use the electrical circuit is operated and the diagnostics module 7 detects various physical later characteristics of the electrical circuit in the known way. The diagnostics module 7 also receives external influence data from the external sensors, and data from the clock 20. The comparison sub-program 12 then takes this inputted data and compares it to the references 17 in the circuit design 11. Where the incoming data corresponds with that in the circuit design 11, within a given tolerance range, the diagnostics module 7 will not act. However, when the incoming data deviates from that in the circuit design 11, the fault warning sub-program 16 issues an appropriate alarm, which is either displayed on the screen 21, or sent to the control system 6, so that appropriate action can be taken.

The incoming data can deviate from that in the circuit design 11 by breaching a threshold, for example a voltage drop of a certain size, or it can deviate from that in the circuit design 11 by simply being incorrect, for example a device tag would be incorrect if the wrong device were connected to the electrical circuit in error.

Likewise, if the circuit design 11 contains a reference 17 stating that the trunk section 2 is short in length, but the incoming data from the circuit includes a high signal

attenuation incompatible with such a short trunk section 2, then a warning alarm can be generated. With known systems such a warning would not occur.

The comparison sub-program 12 can also make inference calculations from the received data. For example, a circuit design may comprise three field devices, each of which draws a different current. If the monitored current in the circuit drops by an amount substantially the same as one of those devices, then the diagnostics module 7 can infer that a fault with that particular device has occurred, and an appropriate fault warning can be generated.

In addition the comparison sub-program 12 can make basic inference calculations about one or more unknown characteristics of the electrical circuit by working the incoming data and the references 17. For example, if the length of the trunk section 2 were not known, the comparison sub-program 12 could infer it by calculating the attenuation of a monitored device signal level, then comparing that with known cable and device characteristics forming a part of the circuit design. Such calculations could be carried out automatically, or in response to commands sent to the diagnostics module 7 from the control system 6. This type of functionality can be applied to all parameters, and can work effectively with analysis such as Fourier analysis.

The second aspect of the invention defines a diagnostics module as claimed in any of claims 1 to 12. It will be appreciated that diagnostics module 7 shown in FIG. 3 can be a retro-fit unit for fitting to an existing electrical circuit, and therefore this provides support for the second aspect of the invention.

The electrical circuit described above can be altered without departing from the scope of claim 1. For example, in one alternative embodiment (indicated in FIG. 2) the diagnostics module 7 can be located in the control room 13 along with the control system 6. With such a construction there may be no need for a separate screen and graphical interface sub-program. In another alternative embodiment (not shown) the diagnostics system of the invention is incorporated into control system, in which case the functions of the invention described above are dispersed within a greater control and monitoring system.

In another alternative embodiment (not shown) the diagnostics module can be a mobile unit adapted to be applied to various parts of the electrical circuit. Such a mobile diagnostics module comprises time domain reflectormetry.

Therefore, the present invention provides a diagnostics system which compares monitored physical layer characteristics of an electrical circuit directly with the original design for that circuit. As such the diagnostics system has a significant database of information against which to compare the real-time real-condition incoming data, and to diagnose many more types of faults than were previously possible. In addition, this arrangement is advantageous because it uses the already existing circuit design for a secondary purpose, which increases its functionality and usefulness, and also eliminates the need for specific programming of a diagnostics system, which is costly, time consuming and can contain errors.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An electrical circuit comprising a power supply, one or more devices and a diagnostics system, in which the diagnostics system comprises monitoring means adapted to monitor physical layer characteristics of the electrical circuit, a database containing circuit design data for the electrical circuit, and comparator means adapted to diagnose the status of the monitored physical layer characteristics of the electrical circuit by comparing them with the circuit design data.

2. An electrical circuit as claimed in claim 1 in which the circuit design data comprises a circuit design generated by a circuit design tool, and comprising a plurality of normal operating references.

3. An electrical circuit as claimed in claim 2 in which the normal operating references comprise one or more of: the voltage and/or current level of the circuit design; the length and/or type and/or resistance and/or identity of cables of the circuit design; the signal amplitude and/or identity of devices incorporated into the circuit design; operating parameters of device couplers incorporated into the circuit design.

4. An electrical circuit as claimed in claim 3 in which the monitoring means is adapted to monitor external influences, in which the normal operating references alter according to changes in the external influences, and in which the comparator means is adapted to diagnose the status of the monitored physical layer characteristics of the electrical circuit by comparing them with the normal operating references according to the prevailing monitored external influences.

5. An electrical circuit as claimed in claim 4 in which the external influences monitored by the monitoring means and incorporated into the circuit design comprise one or more of: the air temperature; the air pressure; the air humidity; the time of day; the time of year.

6. An electrical circuit as claimed in claim 5 in which the circuit design comprises a Segment Checker circuit design generated by the Segment Checker open software program.

7. An electrical circuit as claimed in claim 6 in which the diagnostics system comprises a diagnostics module comprising an operating system with a controlling program loaded onto the operating system, in which the database is loaded onto the operating system, in which the controlling program comprises a monitoring sub-program adapted to receive physical layer data from the electrical circuit, a comparison subprogram adapted to compare said physical layer data with normal operating references stored in the database, and a fault warning sub-program adapted to generate fault signals when said physical layer data deviates from the normal operating references by pre-determined margins.

8. An electrical circuit as claimed in claim 7 in which the monitoring sub-program is adapted to receive external influence data from external sensors with which the electrical circuit is used, and in which the fault warning sub-program is adapted to generate fault signals when said physical layer data deviates by pre-determined margins from the normal operating references according to the prevailing monitored external influences.

9. An electrical circuit as claimed in claim 8 in which the comparison sub-program is adapted to make inference calculations about one or more unknown characteristics of the electrical circuit by working the physical layer data received by the monitoring sub-program and/or the normal operating references.

10. An electrical circuit as claimed in claim 9 in which the diagnostics module further comprises a screen, and in which the controlling program comprises a graphical interface sub-program adapted to generate graphics on the screen relating to physical layer data and external influence data received by the monitoring sub-program and/or the normal operating references of the circuit design stored in the database and/or fault warnings generated by the fault warning sub-program.

11. An electrical circuit as claimed in claim 10 in which the electrical circuit comprises a control system adapted to send and receive data signals to and from the one or more devices, in which the diagnostics module further comprises an input/output connected to the control system, and in which the diagnostics module is adapted to send to the control system physical layer data and external influence data received by the monitoring sub-program and/or the normal operating references of the circuit design stored in the database and/or fault warnings generated by the fault warning subprogram.

12. An electrical circuit as claimed in claim 1, in which the electrical circuit is an intrinsically safe power and communications Fieldbus circuit, which conforms to the IEC 61158 protocol.

13. A diagnostics system for use with an electrical circuit as in claim 1.
